(19) United States
(12) Patent Application Publication
(10) Pub. No.: US 2002/0138640 A1
(43) Pub. Date: Sep. 26, 2002

(54) Apparatus and method for improving the delivery of software applications and associated data in web-based systems

(76) Inventors: Uri Raz, Fairlawn, NJ (US); Ytshak Artzi, (US); Yehuda Volk, Tel-Aviv (IL); Shmuel Melamed, Ramat-Gan (IL)

Correspondence Address: Mitchell S. Feller, Esq., Clifford Chance Rogers & Wells LLP, 200 Park Avenue, New York, NY, 10016, US

(21) Appl. No.: 09/746,877

(22) Filed: Dec. 22, 2000

Related U.S. Application Data
(63) Continuation-in-part of application No. 09/120,575, filed on Jul. 22, 1998, now Pat. No. 6,311,221.
(60) Provisional application No. 60/207,632, filed on May 25, 2000.

(51) Int. Cl. G06F 15/16

(52) U.S. Cl. 709/231

(57) ABSTRACT

An improved system for streaming a software application to a plurality of clients comprises a principal server having the software stored thereon as a plurality of blocks and a plurality of intermediate servers between the principal server and the clients. The principal server is configured to stream program and data blocks to downstream devices in accordance with a dynamic prediction of the needs of those devices. The intermediate servers are configured to cache blocks received from connected upstream devices and service requests for blocks issued from downstream devices. In addition, the intermediate servers are further configured to autonomously predict the needs of downstream devices, stream the predicted blocks to the downstream devices, and if the predicted blocks are not present in the intermediate server cache, request those blocks from upstream devices. The intermediate servers can also be configured to make intelligent cache purging decisions with reference to the contents of the caches in other connected devices.

### CROSS-REFERENCE TO RELATED APPLICATIONS

The present application claims the benefit under 35 U.S.C. § 119 of U.S. Provisional Application Serial No. 60/207,632 entitled “Apparatus and Method For Improving the Delivery of Software Applications and Associated Data in Web-Based Systems”, filed May 25, 2000, the entire contents of which is hereby expressly incorporated by reference. This application is also a Continuation-in-Part of U.S. application Ser. No. 09/120,575 entitled “Streaming Modules” and filed on Jul. 22, 1998, the entire contents of which is hereby expressly incorporated by reference.

In addition, the application is related to the following applications: U.S. application Ser. No. 09/237,792 entitled “Link Presentation and Data Transfer”, filed on Jan. 26, 1999 as a continuation-in-part of U.S. application Ser. No. 09/120,575; U.S. Provisional Patent Application Serial No. 60,177 444 entitled “Method and Apparatus for Improving the User-Perceived System Response Time in Web-based Systems” and filed on Jan. 21, 2000; U.S. Provisional Patent Application Serial No. 60/177,736 entitled “Method and Apparatus for Determining Order of Streaming Modules” and filed on Jan. 21, 2000; as well as all continuations, divisionals, and other applications claiming priority from any of the above identified applications.

### FIELD OF THE INVENTION

The present invention relates generally to improving the delivery of software applications and associated data in web-based systems, and more particularly, to a multi-level intelligent caching system customized for use in application streaming environments.

### BACKGROUND

The Internet, and particularly the world-wide-web, is a rapidly growing network of interconnected computers from which users can access a wide variety of information. Initial widespread use of the Internet was limited to the delivery of static information. A newly developing area of functionality is the delivery and execution of complex software applications via the Internet. There are two basic techniques for software delivery, remote execution and local delivery, e.g., by downloading.

In a remote execution embodiment, a user accesses software which is loaded and executed on a remote server under the control of the user. One simple example is the use of Internet-accessible CGI programs which are executed by Internet servers based on data entered by a client. A more complex systems is the Win-to-Net system provided by Menta Software. This system delivers client software to the user which is used to create a Microsoft Windows style application window on the client machine. The client software interacts with an application program executing on the server and displays a window which corresponds to one which would be shown if the application were installed locally. The client software is further configured to direct certain I/O operations, such as printing a file, to the client's system, to replicate the “feel” of a locally running application. Other remote-access systems, such as provided by Citrix Systems, are accessed through a conventional Internet browser and present the user with a “remote desktop” generated by a host computer which is used to execute the software.

Because the applications are already installed on the server system, remote execution permits the user to access the programs without transferring a large amount of data. However, this type of implementation requires the supported software to be installed on the server. Thus, the server must utilize an operating system which is suitable for the hosted software. In addition, the server must support separately executing program threads for each user of the hosted software. For complex software packages, the necessary resources can be significant, limiting both the number of concurrent users of the software and the number of separate applications which can be provided.

In a local delivery embodiment, the desired application is packaged and downloaded to the user's computer. Preferably, the applications are delivered and installed as appropriate using automated processes. After installation, the application is executed. Various techniques have been employed to improve the delivery of software, particularly in the automated selection of the proper software components to install and initiation of automatic software downloads. In one technique, an application program is broken into parts at natural division points, such as individual data and library files, class definitions, etc., and each component is specially tagged by the program developer to identify the various program components, specify which components are dependent upon each other, and define the various component sets which are needed for different versions of the application.

Once such tagging format is defined in the Open Software Description (“OSD”) specification, jointly submitted to the World Wide Web Consortium by Marimba Incorporated and Microsoft Corporation on Aug. 13, 1999. Defined OSD information can be used by various “push” applications or other software distribution environments, such as Marimba's Castanet product, to automatically trigger downloads of software and ensure that only the needed software components are downloaded to the client in accordance with data describing which software elements a particular version of an application depends on.

Recently, attempts have been made to use streaming technology to deliver software to permit an application to begin executing before it has been completely downloaded. Streaming technology was initially developed to deliver audio and video information in a manner which allowed the information to be output without waiting for the complete data file to download. For example, a full-motion video can be sent from a server to a client as a linear stream of frames instead of a complete video file. As each frame arrives at the client, it can be displayed to create a real-time full-motion video display. However, unlike the linear sequences of data presented in audio and video, the components of a software application may be executed in sequences which vary according to user input and other factors.

To address this issue, as well as other deficiencies in prior data streaming and local software delivery systems, an improved technique of delivering applications to a client for local execution has been developed. This technique is described in co-pending U.S. patent application Ser. No. 09/120,575, entitled “Streaming Modules” and filed on Jul. 22, 1998.

In a particular embodiment of the “Streaming Modules” system, a computer application is divided into a set of modules, such as the various Java classes and data sets which comprise a Java applet. Once an initial module or module set is delivered to the user, the application begins to execute while additional modules are streamed in the background. The modules are streamed to the user in an order which is selected using a predictive model to deliver the modules before they are required by the locally executing software. The sequence of streaming can be varied dynamically response to the manner in which the user operates the application to ensure that needed modules are delivered prior to use as often as possible.

One challenge in implementing a predictive streaming system is maintaining an acceptable rate of data delivery to a client, even when many clients are executing streaming applications. A technique which has been used to improve the delivery time of Internet hosted data accessed by many users is to use caching techniques. In standard Internet-based web-page distribution systems, caching systems are linked between a primary server hosting the web site and the end users or clients, with each cache server servicing a number of corresponding clients. These cache servers are used to store web pages that have been requested by a client from a principal server. Each time a client requests a particular web page, the request is processed by the respective cache server which is servicing the client. If the requested page is present in the cache server, the page is extracted from the cache and returned to the client. If the requested page has not been previously accessed by any of the clients corresponding to the particular cache server, the cache server forwards the request to the primary server to download the page from the Web site, stores the retrieved web page, and serves that page to the client.

Although effective in improving the serving of static web pages to multiple users, conventional caching techniques are not optimized for use in streaming software applications and associated data to users of streaming application delivery services. In particular, conventional caching systems are not optimized for use in an application streaming environment which utilizes predictive models to determine which application components to send to a given client and in what order.

Accordingly, there is a need for an improved network caching system which is optimized to work with a predictive application streaming system.

### SUMMARY OF THE INVENTION

The present invention relates generally to a method and system for improving the delivery of software applications and associated data, which can be stored in databases, via a network, such as the Internet. One or more intermediate tiers of intelligent caching servers are placed between a principal application server and the streaming application clients. The intermediate servers store streamed blocks, such as software application modules or streamlets and other database modules, as they are transmitted from the principal server to a client. As a result, further requests by the same client or other clients associated with the intermediate servers for previously stored information can be streamed from the intermediate servers without accessing the principal server.

In a particular streaming environment, such as the “Streaming Modules” system, when a user of a client system runs a streaming software application resident on the principal server, data blocks representing code modules and database components for the application are predictively streamed from the principal server to the client in a sequence selected, e.g., in accordance with an analysis of the probable order in which the code modules and database components will be used by the application as it executes. The analysis is preferably dynamically responsive to the actual use of the application on the client system. These code modules and database components are passed to the client via the intermediate servers and those servers retain copies of at least some of the transmitted data.

According to a feature of the invention, predictive streaming routines are executed on the intermediate servers and used to forward cached code modules and database components to a client in a sequence appropriate for the client execution conditions. The predictive streaming routine can also predictively identify uncached modules and components likely to be needed by the client in the future and request those from the primary server so that the elements are available for streaming to the client when needed, even if this need is immediate when the request is made.

According to a further aspect of the invention, the intermediate servers broadcast storage or deletion of cached data to other intermediate servers in the network. This information is used, preferably in conjunction with the predictive streaming functionality, to identify the best blocks to purge from the cache when necessary. In particular, knowledge about the cache contents of upstream and downstream intermediate servers can be used, if a block must be purged from the cache, to determine the cost of replacing a given block in a cache from an upstream server or the likelihood that, if the block is needed by a client, it is available on a downstream server which can service such a client request. Other uses for the broadcast cache content information are also possible.

The principal server may be connected to several top-level intermediate servers, and multiple clients may be connected to the lowest tier intermediate servers. Any number of tiers of intermediate servers can be provided between the highest and lowest tiers. Streaming software blocks not present on a lower tier of intermediate server may be available for access on a higher tier without the need to pass the request to the principal server itself. By increasing the number of intermediate servers results, system scalability with respect to the number of users which can be serviced by a single principal server is increased and fewer connections with the principal server will be required to service those clients.

### BRIEF DESCRIPTION OF THE FIGURES

The foregoing and other features of the present invention will be more readily apparent from the following detailed description and drawings of illustrative embodiments of the invention in which:

FIG. 1 is a high level diagram of a system for streaming software applications to one or more clients;

FIG. 2 is an illustration of a multi-level caching server system configured for use in conjunction with a streaming application server;

FIGS. 3-5 are illustrations of various intermediate server caching scenarios; and

FIG. 6 is a sample weighted directed graph visualization of a program operation for use in streaming prediction.

### DETAILED DESCRIPTION OF THE PREFERRED EMBODIMENT(S)

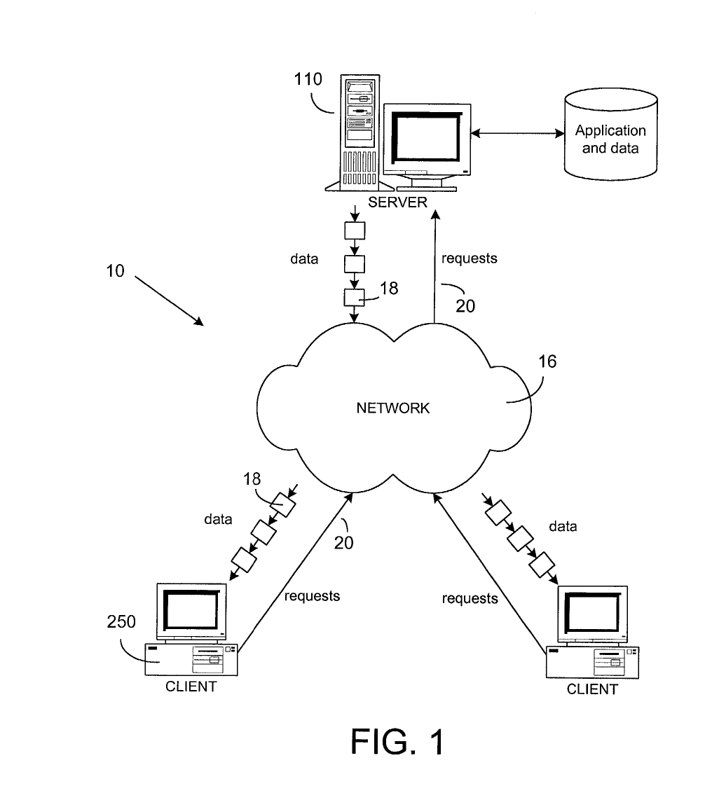

FIG. 1 is a high level diagram of a system 10 for streaming software applications to one or more clients. The system comprises a streaming application server 110 which contains the application to be streamed and associated data. The application to be streamed is broken into discrete parts, segments, modules, etc., also referred to generally herein as blocks. The streams of blocks 18 can be sent individually to a client. Preferably, a predictive model of when the various blocks in the application are used as the program executes is provided at the server and this model issued to select the most appropriate block to send to a client at a given point during the execution of the application on that client's system. Various predictive models can be used, such as a predictive tree, a neural network, a statistical database, or other probabilistic or predictive modeling techniques known to those of skill in the art. Particular predictive techniques are discussed below.

The client can be configured with suitable software to reconstruct the application piecemeal as blocks are received and to execute the application even though the entire application is not locally present. The predictive selection of blocks to send to the client reduces the likelihood that the executing application will require a specific block before it has been sent from the server. If the client does require an absent block, a request 20 can be issued for the missing block The server can also reset its streaming prediction in view of the client request. A particular system of this type is described in parent U.S. application Ser. No. 09/120,575 entitled “Streaming Modules” and filed on Jul. 22, 1998.

The client can be any device capable of utilizing software applications and associated data, including without limitation computers, network appliances, set-top boxes, personal data assistants (PDAs), cellular telephones, and any other devices (present or future) with capability to run or access software or information either locally or via any fiber-optic, wireline, wireless, satellite or other network. The client can transmit and receive data using the Transmission Control Protocol/Internet Protocol (TCP/IP), hypertext transfer protocol (HTTP), and other protocols as appropriate for the client platform and network environment.

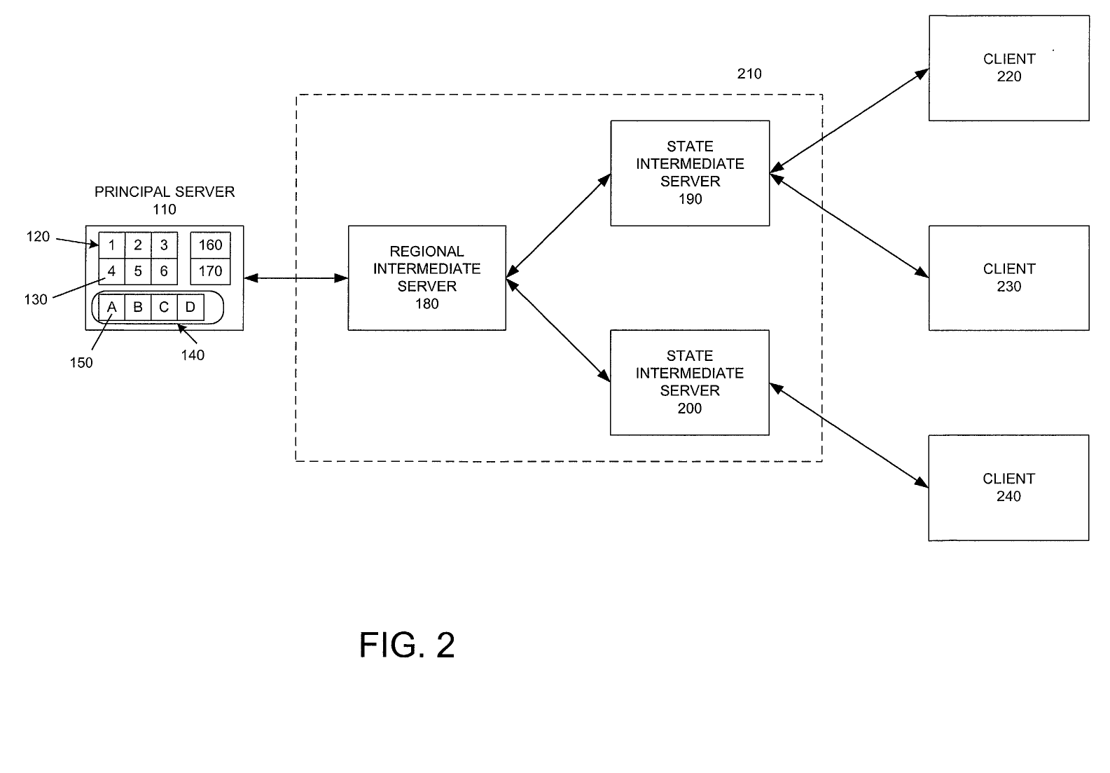

Turning to FIG. 2, there is shown a multi-level caching server system 210 configured for use in conjunction with a principal streaming application server 110. The intermediate servers 210 are situated between the principal server 110 and the various clients 220-240. One or more intermediate servers can be provided to establish multiple paths from the clients to the server 110. In a preferred embodiment, the intermediate servers 210 are arranged in a tree configuration with multiple levels or tiers as shown. The physical location of the intermediate servers 210 which make up the several tiers can vary. For example, a higher level tier server 180 can cover a specific geographic region, while lower level tier servers 190, 200 can cover specific states within that region.

Other network configurations can also be used. In addition, while only two tiers of intermediate servers are shown, any number of tiers may be employed in order to achieve a desired scalability of users for any one potential web site. For purposes of clarity, only one principal server 110, three intermediate servers 210, and three clients 250 are shown. However, those skilled in the art will recognize that the system may include a plurality of principal servers, plurality of intermediate servers, and a plurality of clients.

The principal server 110 contains or has access to a repository of at least one streaming software application 120 comprised of bocks 130, labeled blocks 1-6 in the Figures. The server 110 can also contain or have access to a database 140 containing categories and subcategories of information, which are generally referred to here as database components 150, which components are used by the application 120.

The principal and intermediate servers also contain appropriate software to manage the application streaming and caching operations. In a preferred implementation, the operation of each server is managed by two primary modules—a predictive streaming application 160 and a streaming communication manager 170. Each is discussed below. While the streaming application 160 and streaming manager 170 are discussed herein as separate components, in alternative embodiments, the functions performed by the predictive streaming application 160 and streaming control manager 170 may be combined into one module or the functions divided among several different modules.

The streaming communication manager 170 is configured to manage the storage and retrieval of the streaming application blocks, such as code modules 130 and components of the database 140, as required. The streaming communication manager 170 also contains functionality to manage the data communication links, such as TCP/IP port network communication, with connected devices. During operation, a server will periodically receive requests from a downstream device for a code module 130 or database component 150. Upon receipt of such a request, the streaming manager determines whether the code module or database component is present in local memory or storage. If present, the request is serviced and the appropriate data block or blocks are retrieved from the cache and returned. If the data is not present, the request is transmitted to the next higher tier intermediate server. Ultimately, the request will be submitted to the principal server if the requested blocks are not stored on the client or an intermediate server. For the intermediate servers and the client system, the respective streaming communication managers 170 are further configured to perform caching functions wherein data blocks transmitted from a higher level server are stored and made available for subsequent requests.

As will be recognized by those of skill in the art, the streaming communication manger 170 can be implemented in a variety of ways depending on the computing platform, the type of network interfaces and protocols used, the manner in which the streaming application and database components are stored, as well as other design factors. Suitable implementations of the data retrieval and communications functionality will be known to those of skill in the art.

A primary purpose of the predictive streaming application 160, present on the principal server 110 and the intermediate servers 210, is to anticipate the code blocks 120 and components of the database 140 that will be required at a client 250 during various stages of the execution of a streaming application. In contrast to other streamed data, such as audio or video, execution of the software application 120 may not follow a natural linear order and thus the order in which the application blocks are used by the application can vary. The software application 120 can include jump statements, break statements, procedure calls, and other programming constructs that cause abrupt transfers of execution among sections of executing code. The execution path that is traversed during the processing of interrelated code modules (such as code segments, code classes, applets, procedures, and code libraries) at a client will often be non- linear, user dependent, and may change with each execution of the application program. Because the execution path can vary, the order in which various elements of the application are used also varies.

However, while a natural order may be lacking, an advantageous order can be determined or predicted in which to transparently stream the code modules 130 prior to their execution or need at the client. Various techniques can be used to determine an appropriate order to stream application and database elements. For example, the requests from various clients can be analyzed to determine the relative probability that a given block will be required by the application when in a particular state. The various probabilities can then be considered with reference to a specific application program to determine which blocks are most likely to be needed. The particular predictive method used is not critical to the present invention. A particular predictive technique is discussed below and in more detail in parent U.S. application Ser. No. 09/120,575 entitled “Streaming Modules” and filed on Jul. 22, 1998 and U.S. Provisional Patent Application Serial No. 60/177,736 entitled “Method and Apparatus for Determining Order of Streaming Modules” and filed on Jan. 21, 2000.

During the streaming of an application to a client, the various streaming application managers anticipate or predict the blocks which will be required at a client 250. After this determination is made, the streaming communication manager 170 determines whether the anticipated code modules 120 and database components 150 are present on the particular server. If so, the blocks identified in the prediction process are streamed from the current server to the client. If some or all of the predictive blocks are not present, a request can be submitted by the streaming manager 170 to the next higher level or tier server.

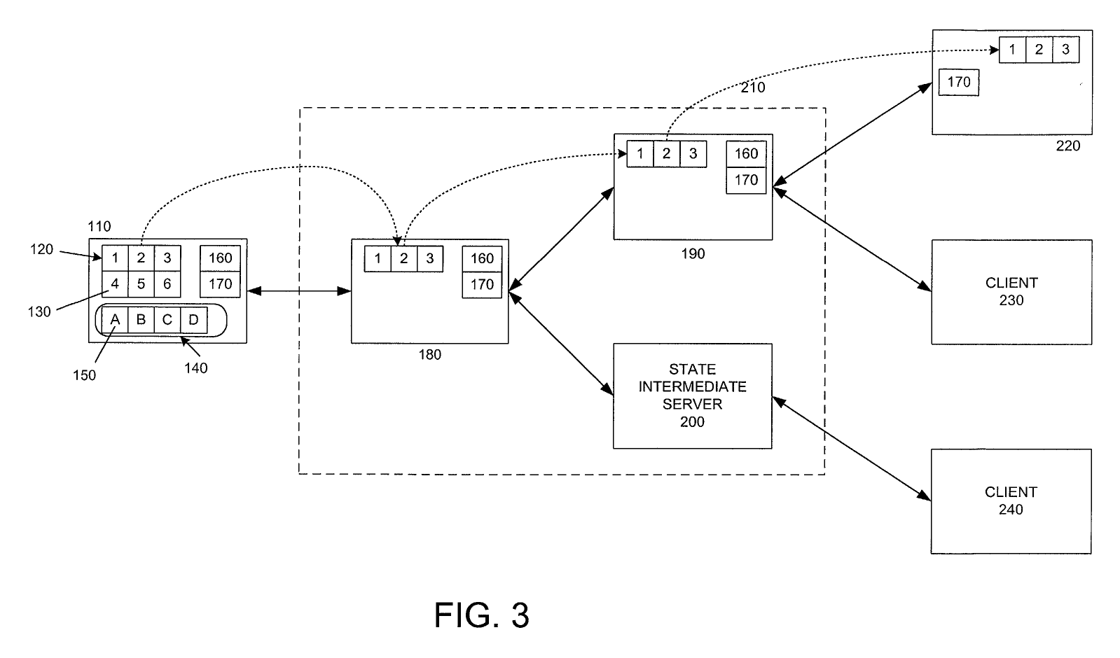

Operation of the presently preferred embodiment of the system 100 utilizing intermediate servers to reduce the number of requests made to a principal server will be discussed with reference to FIGS. 3-5. Turning to FIG. 3, a client 220 has initially accessed the principal server 110 and started the streaming of software application 120. Copies or appropriate versions of the predictive streaming application 160 and streaming communication manager 170 are loaded onto each intermediate server and an appropriate version of the streaming communication manager 170 is installed on the client system. This installation can be performed dynamically on an as-needed basis in response to the client initiating the streaming process or some or all of the modules can be installed on the various servers and clients in advance of the streaming process initiation. Various methods of distributing and installing software known to those of skill in the art can be used for this process.

Upon initiation of the streaming application, the predictive streaming application 160 in the principal server 110 is used to identify one or more blocks, such as code modules 130 and database components 150, from the application 120 which should be streamed to the client 220 via the intermediate servers 210. With reference to the example of FIG. 3, in this instance, the predictive streaming application 160 has determined that code modules 1, 2, and 3 should be streamed to the client 220. These modules are then accessed by the streaming communication manager 170 and transmitted to the client 220 via intermediate servers 180 and 190. In addition to being stored on the client 220, the transmitted code modules are cached at the intermediate servers 180, 190 to reduce the number of requests that need to be made to the principal server 110 from other clients attached to those servers and thereby permit the principal server 110 to support a greater number of streaming application clients without a reduction in principal server performance due to excessive requests.

Should a second client 230 desire to access software application 120, this request can be monitored by intermediate server 190 and, if its predictive streaming application 160 determines that code modules 1, 2, and 3 are required, client 230 need not make a connection with principal server 110 since the required code modules can be streamed directly from intermediate server 190.

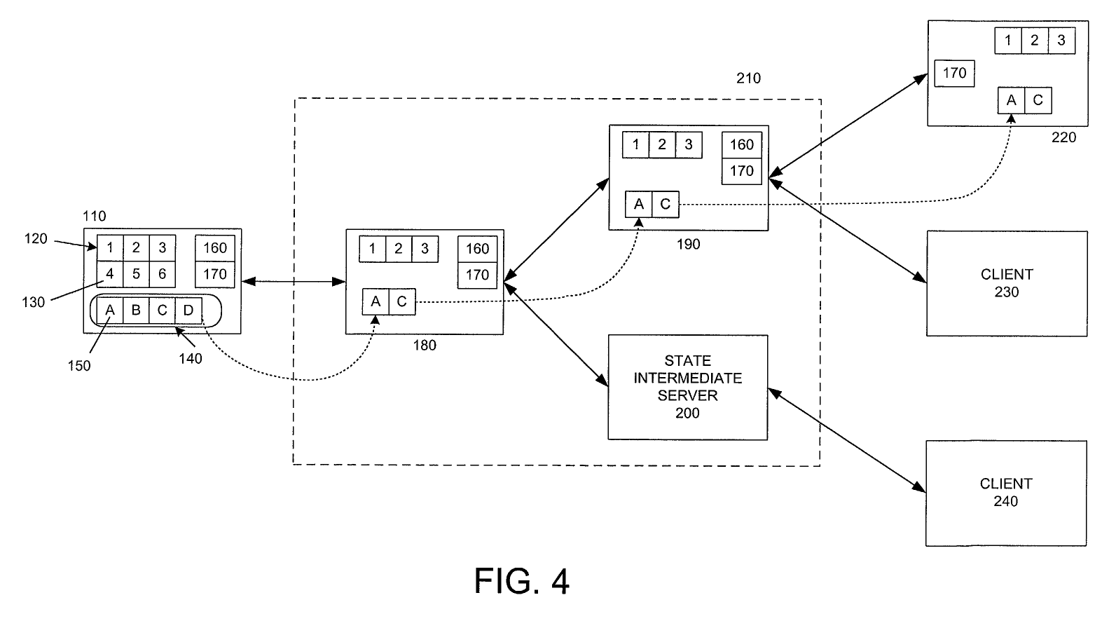

As client 220 begins execution of the streamed application, the application may require (unpredicted) access to data stored in database 140 at the principal server 110. With reference to FIG. 4, client 220 submits the request which is passed to principal server 110 by the intermediate servers 190, 180. The principal server 110 then extracts the required data, such as tables A and C, from the database and returns the data via the intermediate servers to the client. The data can be cached at the intermediate servers 180, 190 as shown in FIG. 4.

The caching of database information on the intermediate servers is particularly effective in reducing the load on principal servers since database information requested may often involve large quantities of data, thereby occupying the principal server for an extended period of time if obtained from the website server. According to a particular aspect of the preferred embodiment, when a client 220 writes to a database 140, as opposed to reading information, the information to be written is transmitted to the principal server 110 for storage and not modified or stored by any of the intermediate servers 210. In addition, database components cached on each intermediate server containing information corresponding to the new information are deleted on each such intermediate server.

As discussed above, one aspect of the predictive streaming application 160 on the principal server 100 and the intermediate servers 210 is to anticipate the code modules 120 and components of the database 140 that will be required at a client 250 as the application is executed. According to the invention, the presence of a streaming manager on each intermediate server 210 and client 250 serves to manage and keep track of the storage and retrieval of each code module and the information from database 140 in a manner which is more suitable for streaming applications than conventional caching systems.

In a particular advantageous configuration of this version of the invention, the focus of each server is generally narrowed such that any particular streaming server makes predictions only for what the connected downstream child servers (or clients for the lowest tier of intermediate servers) are likely to need. If the blocks which are to be predictively streamed are not present on a given server, then a request is issued to the immediate parent server or, for the highest intermediate server tier, to the principal server for those blocks. Advantageously, this configuration reduces the number of simultaneous predictive streams which must be supported by a given server to the number of direct child servers or clients and can also simplify the general operation of the servers since each tier of servers will essentially operate in a manner similar to other tiers. As will be recognized, different predictive models or different weightings in the models can be used at different tiers in the network. Further, this configuration also serves to aggregate and combine requests from individual clients at higher tiers in the network such that individual client differences are masked at the high tiers and the general set of block requests is homogenized. As a result, the further from the client a given streaming servers is, the closer the actual set of data blocks required may match a predictive model based on statistical analyses.

Thus, for example, the predictive streaming routine in intermediate server 190 can process an initial request from client 220 to start the streaming application. This request can be forwarded to the upstream intermediate servers and principal server 110 to provide notice that a new client streaming session has begun. In addition, the predictive streaming application 160 in the intermediate server 190 can determine that code modules 1, 2, and 3 should be streamed to the client 220. Since these modules are not initially present on the intermediate server, a request for these modules is forwarded to the parent intermediate sever 180. Similarly, upon receipt of the notification that intermediate server 190 is servicing a new application stream (for client 220), intermediate server 180 can predict which blocks are likely to be required by intermediate server 190 and predictively stream those blocks if available or, if not, request them from the principal server. As the blocks are delivered downstream, in a flow similar to a bucket-brigade, the blocks can be cached at each intermediate server until they are ultimately delivered to the client.

Referring to FIG. 4, a user at client 230 desiring to initiate software application 120 would first access intermediate server 190. If the predictive streaming application on intermediate server 190 determines that code modules 1, 3, and 4 should be streamed to client 230, this information is presented to the streaming control manager on state intermediate server 190 which determines that identifies that modules 1 and 3 are already present on state intermediate server 190 and begins streaming these modules to client 230. The streaming control manager then initiates a connection with its parent intermediate server 180 to request module 4. If this module is not present, the parent intermediate server 180 itself initiates contact with, its parent server, here the principal server 110. Code module 4 is then streamed to the client 230 from the principal server 110 via the intermediate servers 180, 190 which cache the data for subsequent use.

It should be appreciated that, in an alternative scenario, when the parent intermediate server 180 received notice that client 230 had initiated a streaming session, its predictive streaming application 160 can determine that client 230, based e.g., on a client profile, is likely to require module 4 and issue a request to the principal server 110 for that module. As a result, module 4 could be in the process of being delivered to intermediate server 190 even before it issues its request for that module.

To somewhat simplify forwarding of database components to a client, the information from database 140 can be stored on the intermediate servers in groups which indicate what information was requested from each particular client and which program elements. With reference to FIG. 4, for example, if information in tables A and C were requested by code contained in modules 1, 2, and 3, the two database components can be stored as a single group since it is likely that the same set of tables will be requested by another client. Subsequently, if a client requests those database components, the group can be streamed to the client as a single package. Other groupings can also be defined on a dynamic basis in response to client queries.

In an alternative embodiment, information from database 140 can be pre-processed based on initial profiling of usage groups in order to determine logical groupings of categories of information. These logical groupings may subsequently be adjusted based on actual usage patterns. Advantageously, determining these groupings permits the groups to be included in the predictive streaming model so that the groups can be predictively streamed in the same manner as the software application components.

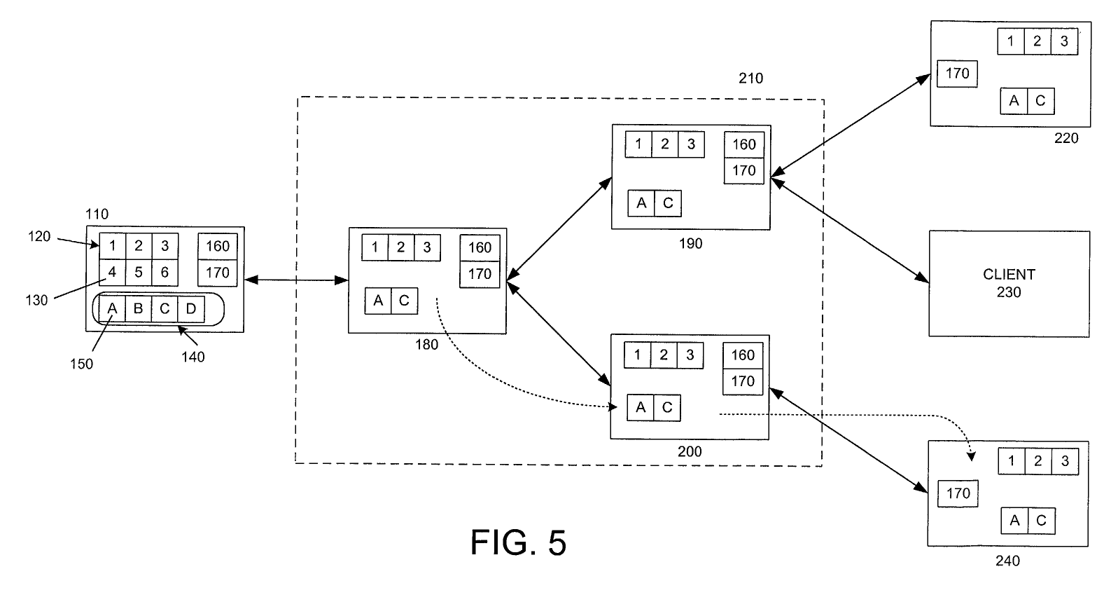

With reference to FIG. 5, client 240 can initiate streaming of the application. The predictive streaming application 160 present on intermediate server 200 determines that software components 1, 2, and 3 will be required and that associated with those program code modules is a database component group comprising database components A and C. The predictive streaming application 160 can request that all of this data be streamed to the client 240. Since it is not initially present locally on intermediate server 200, the data can be requested from the parent intermediate server 180. Alternatively, upon receiving notification of the new streaming client, parent intermediate server 180 can also predict that these blocks will be required and forward them to the intermediate server 200 even prior to receiving a specific request.

According to a further aspect of the invention, when a code module 120 or database component 150 is streamed to and stored at either an intermediate server or client, this information is noticed or broadcast to other intermediate servers in the system to provide an indication to each server of the cached data present on the various servers in the system. For example, with reference to FIG. 3, when the code modules 1, 2, and 3 are cached at intermediate servers 180, 190, this fact can be broadcast to other intermediate servers in the network, such as all child and parent servers, and possibly the various clients connected to that intermediate server as well. As a result of this data sharing, each streaming control manager can be aware of which blocks are stored on each upstream and downstream intermediate server and possibly the modules stored on the individual clients. This information can be used to create maps of the data contents across the intermediate server network for use by the predictive streaming system to determine the modules which may be needed by various clients (i.e., a client does not need to be streamed data it already has).

During the course of operation, it will generally become necessary to purge elements from the cache. According to an aspect of the invention, when it becomes necessary for a given intermediate server to purge elements from its cache, it selects the elements to purge based not only upon the likelihood that a given element will be required in the future, but also on the cost of retrieving that element. Because an intermediate server has knowledge about the contents of other connected intermediate servers, the cost predictions can consider the fact that a deleted element may not need to be retrieved from the principal server, but might instead be available at a closer intermediate server.

For example, with reference to FIG. 4, intermediate server 190 can purge code module 3 with knowledge that this data is also available on parent intermediate server 180, and can thus be retrieved with less penalty than an element which is only present on the principal server 110. Similarly, intermediate server 180 can purge code module 3 knowing that it is available on child intermediate server 190, and thus available to the client to that intermediate server 190. As a result, there are fewer clients which might issue a request for the purged element. Notably, if client 240 is not expected to require module 3, such as, for example, if it is running a different streaming application (or if module 3 is also present on intermediate server 200, as in FIG. 5), then this module can be purged with substantially no penalty. Without knowledge of the contents of the various parent and child intermediate servers, cache purging predictions could not be made as accurately and overall streaming efficiency would be reduced.

In a particular implementation, during operation, an intermediate server to purge data from its cache, the streaming communication manager aggregates several variables for to produce a single reference value I for each of the elements stored in the cache. The reference values can be updated as appropriate, such as each time that particular intermediate server caches a new element and each time it receives notification from another intermediate server that it has stored or purged a particular block. When a cache purge is required, the calculated reference values are compared against a predefined threshold value. If the calculated value is greater than the threshold value, the respective code module 120 or database component 150 block can be deleted from the cache on the server. Preferably, blocks which exceed the respective threshold by the greatest amount are deleted first, followed by blocks with increasingly lower values until the desired amount of cache space has been reclaimed.

There are a variety of particular factors which can be included in the determination of the reference value for a given cached block. These factors can include one or more of the code module or database component size (s), the cost (c) in CPU tasks to stream a given code module or database component to that server if replacement is needed (which can be based on an analysis of the nearest location of that block), quality (q) of transmission line, type (t) of transmission line, cost to store and maintain (m) the code module or database component, distance (d) in nodes on the internet which the code module or database component must be streamed, and frequency (f) of use of the code module or database component, such as based on currently maintained statistics or the predictive model and knowledge of the status of the various streaming clients. As will be appreciated, the value of these factors will change at different rates and some may remain relatively constant across a long period of time. In addition, the thresholds may also vary in response to changing conditions, such as the number of clients executing a given streaming application.

The values can be stored in table format at each server. A sample table is illustrated below:

| Variable | Value | Threshold |
|---|---|---|
| Module/Component size | 317 | 200 |
| Cost to stream | 7 | 10 |
| Quality of transmission line | 5 | 2 |
| Type of transmission line | 4 | 4 |
| Cost to store and maintain | 3 | 5 |
| Distance | 5 | 3 |
| Frequency | 23 | 15 |
| Other inputs | n | N |

The value I can be calculated to compare to a threshold value on each server and computed based on a weighted sum of these variables:

I=Σ(k₁·c, k₂·q, k₃·t, k₄·m, k₅·d, k₁·i, . . . kₙ·iₙ)

In this weighted sum, k₁ . . . k_{N} represents the weights assigned to each variable and i₁, . . . iₙ, represents other variables related from the end user based on adaptive and predictive algorithms, such as those disclosed in the referenced related applications. Each weight value k₁, . . . k₁ as well as each particular threshold value may be adapted to reflect user usage patterns as described in the above referenced applications. The variables c, q, t, m, and d refer to the above described variables.

The calculated value of I is compared to an aggregate threshold value to determine whether it is appropriate to delete the block from the server cache. This aggregate threshold may be set by the system administrator of the system or calculated based on the individual threshold values for each specific variable. As the value of each variable is updated as described above, a new computation of I can be made by the streaming communication manager to determine whether a block can be or should be deleted from the cache.

The structure in which the information from database 140 being cached on intermediate servers 210 is stored may vary. For example, the database information could be structured on the intermediate servers 210 to exactly replicate the structure of database 140 on the principal server 110. In circumstances where are there are database components 150 portions of multiple databases (e.g., portions of an Oracle database, Sybase database, etc.) stored on the intermediate servers 210, the information from each different database is stored independently from the others in its original structure utilizing the original directory. Alternatively, information from multiple originating databases at the principal server 110 can be could be stored in one large database on the intermediate servers 210, utilizing a map of Application Programming Interfaces (APIs) based on the originating databases to enable location of the desired information based upon the clients 220 request. In another alternative, the database information is not stored on the intermediate servers 210 at all, but rather outsourced for storage by a third party and accessed by the intermediate servers 210 when necessary. The streaming manager 160 at each intermediate server will keep track of locator information for database information stored by the third party and transmit such locator information to the third party when database information access is required. Other variations are also possible.

As discussed above, various techniques can be used to predict the order in which a client will require various program elements during execution. The following is a more detailed discussion of a particular technique for predicting this order for use in determining an order in which program elements should be streamed to a particular client. As discussed above, this information can be used in the presently disclosed system, along with additional information, such as the contents of related intermediate servers, download times, etc., by each intermediate server to determine the most appropriate streaming sequences to downstream devices and to further determine program elements which should be requested from upstream devices in anticipation of future needs.

A software application can include multiple modules “A” through “H.” Modules “A” through “H” may be Java Classes, C++ procedure libraries, or other code modules or portions of modules that can be stored at a server,. Some of the modules “A” through “H” may also be stored at the client computer, such as in a hard disk drive cache or as part of a software library stored at the client computer. When a client computer begins execution of the application, a first module, such as module “A,” can be downloaded from the server and its execution at the client can begin. As module “A” is being processed, the programming statements contained therein may branch to, for example, module “E.”

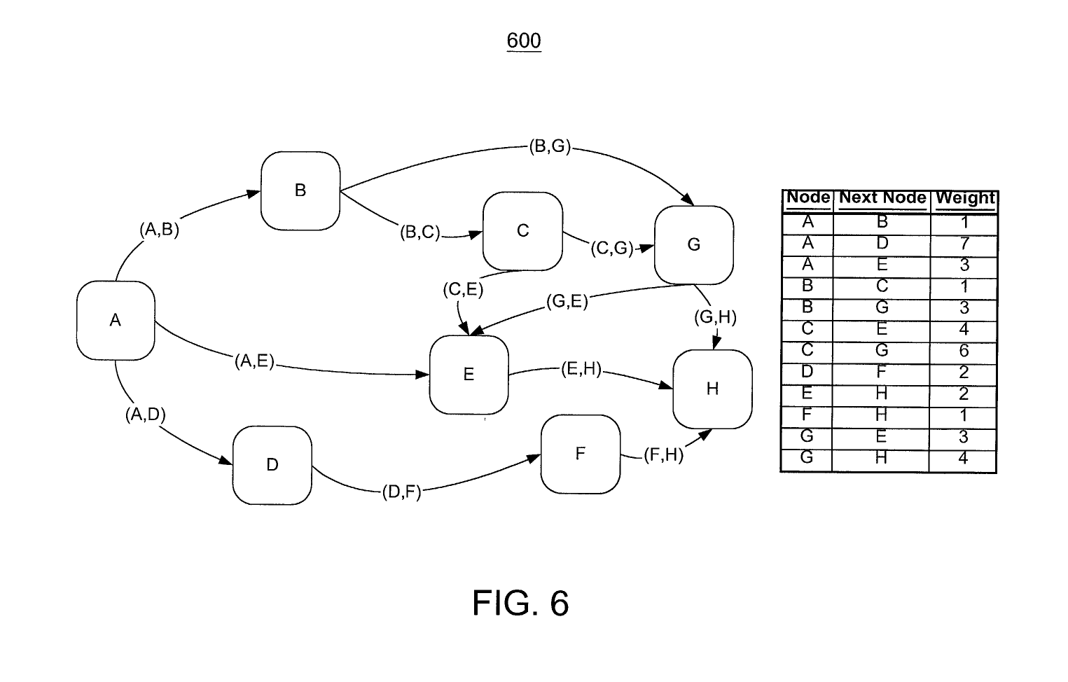

To minimize module download delays experienced by a user, module “E” may be transparently streamed from a server to the client computer before it is required at the client. Transparent streaming allows future module use to be predicted and modules to be downloaded while other interrelated modules “A” are executing. Referring to FIG. 6, the execution order of application modules “A” through “H” can be visualized as a directed graph 600 rather than a linear sequence of modules. For example, as illustrated by the graph, after module “A” is executed, execution can continue at module “B,” “D,” or “E.” After module “B” is executed, execution can continue at module “C” or “G.” The execution path may subsequently flow to additional modules and may return to earlier executed modules.

The sequence of modules to send to the client can be determined in a variety of ways. In the graph based implementation of the present example, predictive data can be provided representing all possible transitions between the modules “A” through “H” of graph along with weighted values indicating the likelihood that the respective transition will occur. A sample table 600 is shown in FIG. 6, where higher weight values indicate less likely transitions.

A shortest-path graph traversal algorithm (also known as a “least cost” algorithm) can be employed to determine a desirable module streaming sequence based on the currently executing module at the client. Example shortest-path algorithms may be found in Telecommunications Networks: Protocols, Modeling and Analysis, Mischa Schwartz, Addison Wesley, 1987, § 6. For example, the following Table 1 shows the minimum path weight between module “A” and the remaining modules:

TABLE 1
Shortest Paths from Application Module “A”:

| | | Shortest | |
|---|---|---|---|
| | | Path | |
| From | To | Weight | Path |
| A | B | 1 | A-B |
| | C | 2 | A-B-C |
| | D | 7 | A-D |
| | E | 3 | A-E |
| | F | 9 | A-D-F |
| | G | 4 | A-B-G |
| | H | 5 | A-E-H |

Based on the weight values shown, the server may determine that, during the execution of module “A”, the module streaming sequence “B,” “C,” “E,” “G,” “H,” “D,” “F” is advantageous.

If a particular module in a determined sequence is already present at the client, the server may eliminate that module from the stream of modules. If, during the transmission of the sequence “B,” “C,” “E,” “G,” “H,” “D,” “F,” execution of module “A” completes and execution of another module begins, as may be indicated by a communication from the client, the server can interrupt the delivery of the sequence “B,” “C,” “E,” “G,” “H,” “D,” “F,” calculate a new sequence based on the now executing module, and resume streaming based on the newly calculated streaming sequence. For example, if execution transitions to module “B” from module “A,” control data can be sent from the client indicating that module “B” is the currently executing module. If module “B” is not already available at the client, the server will complete delivery of module “B” to the client and determine a new module streaming sequence.

By applying a shortest-path routing algorithm to the edges of Table 600 FIG. 6 based on module “B” as the starting point, the minimum path weights between module “B” and other modules of the graph 600 can be determined, as shown in Table 2, below:

TABLE 2
Shortest Paths from Module B

| | | Shortest | |
|---|---|---|---|
| | | Path | |
| From | To | Weight | Path |
| B | C | 1 | B-C |
| | E | 5 | B-C-E |
| | G | 3 | B-G |
| | H | 7 | B-C-E-H |

Based on the shortest path weights shown in Table 2, the server 401 may determine that module streaming sequence “C,” “G,” “E,” and “H” is advantageous.

Other algorithms may also be used to determine a module streaming sequence. For example, a weighted graph 600 may be used wherein heavier weighted edges indicate a preferred path among modules represented in the graph. In Table 3, higher assigned weight values indicate preferred transitions between modules. For example, edges (A,B), (A,D), and (A,E) are three possible transitions from module A. Since edge (A,B) has a higher weight value then edges (A,D) and (A,E) it is favored and therefore, given module “A” as a starting point, streaming of module “B” before modules “D” or “E” may be preferred. Edge weight values can be, for example, a historical count of the number of times that a particular module was requested by a client, the relative transmission time of the code module, or a value empirically determined by a system administrator and stored in a table at the server. Other edge weight calculation methods may also be used.

TABLE 3
Preferred Path Table

| Edge | Weight |
|---|---|
| (A, B) | 100 |
| (A, D) | 15 |
| (A, E) | 35 |
| (B, C) | 100 |
| (B, G) | 35 |
| (C, E) | 50 |
| (C, G) | 20 |
| (D, F) | 50 |
| (E, H) | 50 |
| (F, H) | 100 |
| (G, E) | 35 |
| (G, H) | 25 |

In an preferred-path (heavy weighted edge first) implementation, edges in the graph 300 having higher weight values are favored. The following exemplary algorithm may be used to determine a module streaming sequence in a preferred-path implementation:

1: Create two empty ordered sets:

i) A candidate set storing pairs (S,W) wherein “S” is a node identifier and “W” is a weight of an edge that may be traversed to reach node “S.”

ii) A stream set to store a determined stream of code modules.

2: Let Si be the starting node.

3: Append the node Si to the Stream Set and remove any pair (Si, W) from the candidate set.

4: For each node Sj that may be reached from node Si by an edge (Si, Sj) having weight Wj:

If Sj is not a member of the stream set then add the pair (Sj, Wj) to the candidate set.

If Sj appears in more than one pair in the candidate set, remove all but the greatest-weight (Sj, W) pair from the candidate set.

5:If the Candidate set is not empty

Select the greatest weight pair (Sk,Wk) from the candidate set.

Let Si=Sk

Repeat at step 3

For example, as shown in Table 4, below, starting at node “A” and applying the foregoing algorithm to the edges of Table 3 produces the stream set {A, B, C, E, H, G, D, F}:

TABLE 4
Calculation of Stream Set

| Iteration | {Stream Set}/{Candidate Set} |
|---|---|
| 1 | {A}/{(B, 100)(D, 15)(E, 35)} |
| 2 | {A, B}/{(D, 15)(E, 35)(C, 100)(G, 35)} |
| 3 | {A, B, C}/{(D, 15)(E, 35)(G, 35)} |
| 4 | {A, B, C, E}/{(D, 15)(G, 35)(H, 50)} |
| 5 | {A, B, C, E, H}/{(D, 15)(G, 35)} |
| 6 | {A, B, C, E, H, G}/{(D, 15)} |
| 7 | {A, B, C, E, H, G, D}/{(F, 50)} |
| 8 | {A, B, C, E, H, G, D, F}/{} |

Implementations may select alternative algorithms to calculate stream sets and the predictive streaming process can be dynamically updated should a user request a module that was not predicted and used to predict a new module sequence starting from the requested module.

While the present invention has been described with reference to the preferred embodiment therein, variations in form and implementation can be made without departing from the spirit and scope of the invention. In particular, for example, the present description has referenced code modules streamed from the principal server 110. These modules can be executable or non-executable data, including without limitation Java classes, C++ procedure libraries, other code modules, multimedia files, hypertext markup language (HTML) pages, dynamic HTML pages, XML data, or other data associated with URL addresses. Other techniques can also be used to divide the application into blocks which are appropriate for use in a streaming application environment. In addition, while the present invention has been discussed with reference to client-server methodologies, the invention is also applicable to other data network configurations which depart from a strict client-server model.

1. A system for streaming a software application to a plurality of clients comprising:
a principal server having the software stored thereon as a plurality of blocks and comprising a principal predictive streaming application configured to predict blocks which will be required by devices connected to the principal server, and a principal streaming communication manager configured to transmit predicted blocks to designated devices connected to the principal server and service requests for blocks issued from downstream devices;
at least one intermediate server connected between the principal server and the plurality of clients, each intermediate server connected to at least one upstream device and at least one downstream device and comprising a cache, a respective intermediate predictive streaming application configured to predict blocks which will be required by connected downstream devices, and a respective intermediate streaming communication manager;
each respective intermediate streaming communication manager configured to (a) transmit predicted blocks to designated downstream devices, (b) service requests for blocks issued from downstream devices, (c) cache blocks received from connected upstream devices, and (d) issue requests for a particular block to an upstream device when the particular block is needed for transmission to a downstream device and is not present in the cache;
wherein each device comprises one of an intermediate server and a client.

2. The system of claim 1, wherein the intermediate streaming communication manager is further configured to, in response to an indication that a cache purge is required, select at least one block to purge in accordance with a determination of a cost to replace particular blocks in the cache.

3. The system of claim 2, wherein the intermediate communication streaming manager is further configured to determine the cost to replace particular blocks in the cache with reference to cached contents at connected devices.

4. The system of claim 3 wherein the intermediate communication streaming manager is further configured to broadcast to at least some of the connected devices indications of caching and purging events.

5. The system of claim 4, wherein the intermediate communication streaming manager is configured to broadcast caching and purging event indications to direct descendant and direct ancestor devices.

6. The system of claim 1, wherein the intermediate streaming communication manager is further configured to:
generate a reference value for each block in the associated cache related to a cost to replace the particular block in the cache; and
upon a determination that a cache purge is required, select at least one block to purge from a set of blocks having a reference value exceeding a predefined threshold.

7. The system of claim 6, wherein the cost is determined with reference to cached contents at connected devices.

8. The system of claim 7, wherein the intermediate streaming communication manager is further configured to recalculate the reference values for blocks in the associated cache upon a receipt of a broadcast from a connected device indicating a change in cache contents at that connected device.

9. The system of claim 8, wherein the intermediate streaming communication manager is further configured to broadcast to at least some of the connected devices indications of caching and purging events.

10. The system of claim 6, wherein the cost for a respective block is determined with reference to at least one of:
a block size;
a cost in CPU tasks to stream the respective block to the intermediate server from a connected device which is an alternative source of the respective block;
quality of transmission line to the alternative source of the respective block;
type of transmission line to the alternative source of the respective block;
cost to store and maintain the block at the particular intermediate server;
distance in network nodes to the alternative source of the respective block; and
frequency of use of the respective block.

11. The system of claim 1, wherein the intermediate predictive streaming application is configured to predict blocks which will be required by immediate downstream descendant devices.

12. The system of claim 1, wherein the intermediate streaming communication manager is configured to request blocks from upstream devices in accordance with the prediction of blocks which will be required by downstream devices.

13. A server for use in a system for streaming a software application to a plurality of clients comprising:
a cache;
a predictive streaming application configured to predict blocks which will be required by connected downstream devices; and
a streaming communication manager configured to (a) transmit predicted blocks to designated downstream devices, (b) service requests for blocks issued from downstream devices, (c) cache blocks received from connected upstream devices, and (d) issue requests for a particular block to an upstream device when the particular block is needed for transmission to a downstream device and is not present in the cache;
wherein each device comprises one of a server and a client.

14. The system of claim 13, wherein the streaming communication manager is configured to request blocks from an upstream device in accordance with the prediction of blocks which will be required by a connected downstream device.

15. The system of claim 13, wherein the streaming communication manager is further configured to, in response to an indication that a cache purge is required, select at least one block to purge in accordance with a determination of a cost to replace particular blocks in the cache.

16. The system of claim 14, wherein the communication streaming manager determines the cost to replace particular blocks in the cache with reference to cached contents at devices connected to the server.

17. The system of claim 15 wherein the communication streaming manager is configured to broadcast to at least some devices connected to the server indications of caching and purging events.

18. The system of claim 16, wherein devices connected to the server are organized in a tree configuration and the communication streaming manager is configured to broadcast caching and purging event indications to direct descendant and direct ancestor devices connected to the server.

19. The system of claim 13, wherein the streaming communication manager is further configured to:
generate a reference value for each block in the associated cache related to a cost to replace the particular block in the cache; and
upon a determination that a cache purge is required, select at least one block to purge from a set of blocks having a reference value exceeding a predefined threshold.

20. The system of claim 18, wherein the cost is determined with reference to cached contents at devices connected to the server.

21. The system of claim 19, wherein the streaming communication manager is further configured to recalculate the reference values for blocks in the associated cache upon a receipt of a broadcast from a device connected to the server indicating a change in cache contents at that connected device.

22. The system of claim 20, wherein the streaming communication manager is further configured to broadcast to at least some devices connected to the server indications of caching and purging events.

23. The system of claim 18, wherein the cost for a respective block is determined with reference to at least one of:
a block size;
a cost in CPU tasks to stream the respective block to the server from a connected device which is an alternative source of the respective block;
transmission line quality to the alternative source of the respective block;
transmission line type to the alternative source of the respective block;
cost to store and maintain the block at the particular intermediate server;
distance in network nodes to the alternative source of the respective block from the intermediate server; and
frequency of use of the respective block.

24. The system of claim 13 wherein the predictive streaming application is configured to predict blocks which will be required by immediate downstream descendant devices connected to the server.

25. In a system for streaming a software application as blocks from a principal server to at least one client having at least one intermediate server between the principal server and the client, each intermediate server connected to at least one upstream device and at least one downstream device, each device comprising one of the principal server, a client, and another intermediate server, a method for improving the deliver of the software application comprising the steps of:
predicting at the intermediate server blocks which will be required by a downstream device;
transmitting predicted blocks from the intermediate server to a designated downstream device;
caching blocks at the intermediate server received from an upstream device in a cache;
receiving requests at the intermediate server from a particular downstream device for a particular block; and
issuing requests for the particular block from the intermediate server to the upstream device when the requested particular block is not present in the intermediate server cache; and
transmitting the particular block from intermediate server to the particular downstream device.

26. The method of claim 25, further comprising the step of issuing requests from the intermediate server to the upstream device for blocks which have been predicted to be required by a connected downstream device and are not in the intermediate server cache.

27. The method of claim 25, further comprising the step of:
determining the cost to replace particular blocks in the intermediate server; and
in response to an indication that a cache purge is required at the intermediate server, selecting at least one block to purge from the intermediate server cache in accordance with the determined cost.

28. The method of claim 26, wherein the step of determining the cost comprises considering cache contents at devices connected to the intermediate server.

29. The method of claim 27, further comprising the step of broadcasting from the intermediate server indications of caching and purging events.

30. The method of claim 25, further comprising the steps of:
generating a reference value for each block in the intermediate server cache, the reference value related to a cost to replace the particular block in the cache; and
upon a determination that a cache purge is required at the intermediate server, selecting at least one block to purge from a set of blocks having a reference value exceeding a predefined threshold.

31. The method of claim 30, wherein the cost is determined with reference to cached contents at devices connected to the intermediate server.

32. The method of claim 31, further comprising the step of recalculating the reference values for blocks in the intermediate server cache upon a receipt at the intermediate server of broadcast from a connected device indicating a change in cache contents at that connected device.

33. The method claim 32, further comprising the step of broadcasting from the intermediate server to at least some devices connected to the server indications of caching and purging events at the intermediate server.

34. The method of claim 30, wherein the generated cost is determined with reference to at least one of:
a block size;
a cost in CPU tasks to stream the respective block to the intermediate server from a connected device which is an alternative source of the respective block;
transmission line quality to the alternative source of the respective block;
transmission line type to the alternative source of the respective block;
cost to store and maintain the block at the intermediate server;
distance in network nodes to the alternative source of the respective block from the intermediate server; and
frequency of use of the respective block.

35. A computer program product for use a system for streaming a software application as blocks from a principal server to at least one client having at least one intermediate server between the principal server and the client, each intermediate server connected to at least one upstream device and at least one downstream device, each device comprising one of the principal server, a client, and another intermediate server, the computer program product comprising computer code to configure an intermediate server to:
predict blocks which will be required by a downstream device;
transmit predicted blocks to a designated downstream device;
cache blocks received from an upstream device in a cache;
receive requests from a particular downstream device for a particular block; and
issue requests for the particular block to the upstream device when the requested particular block is not present in the cache; and
transmit the particular block to the particular downstream device.

36. The computer program product of claim 35, further comprising computer code to configure the intermediate server to issue requests to the upstream device for blocks which have been predicted to be required by a connected downstream device and are not in the cache.

37. The computer program product of claim 35, further comprising computer code to configure the intermediate server to:
determine the cost to replace particular blocks in the cache; and
when a cache purge required, select at least one block to purge from the cache in accordance with the determined cost.

38. The computer program product of claim 36, further comprising computer code to determine the cost with reference to cache contents devices connected to the intermediate server.

39. The computer program product of claim 37, further comprising computer code to configure the intermediate server to broadcast indications of caching and purging events.

40. The computer program product of claim 35, further comprising computer code to configure the intermediate server to:
generate a reference value for each block in the cache, the reference value related to a cost to replace the particular block in the cache; and
upon a determination that a cache purge is required at the intermediate server, select at least one block to purge from a set of blocks having a reference value exceeding a predefined threshold.

41. The computer program product of claim 40, wherein the cost is determined with reference to cached contents at devices connected to the intermediate server.

42. The computer program product of claim 35, further comprising computer code to configure the intermediate server to recalculate the reference values for blocks in the cache upon a receipt at the intermediate server of broadcast from a connected device indicating a change in respective cache contents at that connected device.

43. The computer program product of claim 42, further comprising computer code to configure the intermediate server to broadcast to at least some devices connected to the server indications of caching and purging events.

44. The computer program product of claim 40, wherein the cost is determined with reference to at least one of:
a block size;
a cost in CPU tasks to stream the respective block to the intermediate server from a connected device which is an alternative source of the respective block;
transmission line quality to the alternative source of the respective block;
transmission line type to the alternative source of the respective block;
cost to store and maintain the block at the intermediate server;
distance in network nodes to the alternative source of the respective block from the intermediate server; and
frequency of use of the respective block.
